(19) United States
(12) Patent Application Publication
(10) Pub. No.: US 2025/0211489 A1
(43) Pub. Date: Jun. 26, 2025

(54) CI/CD FRAMEWORK TO INSTALL 5G APPLICATIONS

(71) Applicant: DISH Wireless L.L.C., Littleton, CO (US)

(72) Inventors: Zeev Render, Ashburn, VA (US); Sundeep Goswami, Leesburg, VA (US)

(21) Appl. No.: 18/986,317

(22) Filed: Dec. 18, 2024

Related U.S. Application Data
(60) Provisional application No. 63/613,890, filed on Dec. 22, 2023.

(51) Int. Cl. H04L 41/0873; H04L 41/0859

(52) U.S. Cl. CPC H04L 41/0873; H04L 41/0859

(57) ABSTRACT

Systems, devices, and methods for deployment of software applications on a cloud platform are provided. An example method includes receiving in the cloud-agnostic CI/CD system an artifact associated with an application to be deployed on a target cloud platform from a service vendor, extracting configuration parameters specific to the target cloud platform of the application from the artifact, selecting a predetermined cloud-agnostic configuration template containing standardized configuration parameters, mapping the cloud-specific configuration parameters to the standardized configuration parameters, determining a reference configuration setting based on the cloud-agnostic configuration template, storing by the reference configuration determination device the reference configuration setting in a repository as a single source of truth, applying the reference configuration setting to the cloud-agnostic configuration template to generate an initial deployment script, and executing the initial deployment script to deploy the application on the target cloud platform.

### CROSS REFERENCE TO RELATED APPLICATIONS

This application claims priority to U.S. Provisional Patent Application No. 63/613,890, filed on Dec. 22, 2023, the disclosure of which is incorporated by reference in its entirety for all purposes.

### BACKGROUND

Cellular networks, including the Fifth Generation (5G) open radio access networks (O-RAN), have undergone a significant transformation. Historically, up to and including 4G Long Term Evolution (LTE) networks, many components within cellular networks were reliant on specialized hardware. However, the emergence of 5G has introduced a fundamental shift towards the implementation of cellular network components as software executed on general-purpose hardware platforms. The advent of 5G brings forth a crucial evolution in network architecture and service provisioning. As service vendors seek to harness the capabilities of 5G, they encounter the complexities associated with the transition from hardware-centric to software-centric deployments.

The software-based approach has allowed for the deployment of cellular network functions as software, running on adaptable and general-purpose hardware, leading to greater flexibility, scalability, and adaptability within cellular networks. Service vendors are now exploring advanced cloud computing models to facilitate the development, deployment, and management of applications that harness the potential of 5G networks. These cloud computing models provide a development environment where service vendors can develop, test, and package their software applications efficiently. Many of these cloud environments also employ containerization technologies, such as Docker, and container orchestration frameworks like Kubernetes. These technologies allow service vendors to encapsulate their software applications within containers and enable deployment within managed clusters on the cloud. Furthermore, these cloud environments can incorporate DevOps methodologies and support continuous integration/continuous deployment (CI/CD) pipelines.

In the context of 5G networks and applications, however, challenges lie in integrating these software-based applications with 5G network elements, including the core network, radio access network, and edge computing infrastructure. Traditional deployment methods often involve service vendors relying on on-premises or in-house infrastructure or specific cloud platforms. A common issue is the need for service vendors to engage individually with each cloud provider to deploy applications on their respective cloud platforms. Different cloud providers may provide distinct services, configurations, and interfaces, which may add significant complexity when the service vendor deploys an application across multiple different cloud platforms.

### SUMMARY

In accordance with some embodiments of the present disclosure, a computer-implemented method is provided. In one example, a method is performed by a cloud-agnostic continuous integration/continuous deployment (CI/CD) system. The CI/CD system includes an analytics device, a standardization device, a reference configuration determination device, a configuration device, a script generation and management device, and an execution device. The method includes receiving in the cloud-agnostic CI/CD system an artifact associated with an application to be deployed on a target cloud platform from a service vendor, extracting by the analytics device configuration parameters specific to the target cloud platform of the application from the artifact, selecting by the standardization device a predetermined cloud-agnostic configuration template containing standardized configuration parameters, mapping by the standardization device the cloud-specific configuration parameters to the standardized configuration parameters, determining by the reference configuration determination device a reference configuration setting based on the cloud-agnostic configuration template, storing by the reference configuration determination device the reference configuration setting in a repository in the cloud-agnostic CI/CD system, and the repository is used as a single source of truth during deployment and lifecycle management of the application. The method further includes applying by the configuration device the reference configuration setting to the cloud-agnostic configuration template to generate an initial deployment script and executing by the execution device the initial deployment script to deploy the application on the target cloud platform.

In accordance with some embodiments of the present disclosure, a cloud-agnostic CI/CD pipeline and orchestration framework/system is provided. In one example, the system includes: one or more processors and a computer-readable storage media storing computer-executable instructions. The computer-executable instructions, when executed by the one or more processors, cause the system to perform any method described herein.

In accordance with some embodiments, the present disclosure also provides a non-transitory machine-readable storage medium encoded with instructions, the instructions executable to cause one or more electronic processors of a computer system or computer device to perform any one of the methods described in the present disclosure.

### BRIEF DESCRIPTION OF THE DRAWINGS

FIG. 1A illustrates an embodiment of a cellular network, in accordance with various embodiments according to the present disclosure.

FIG. 1B illustrates an example of a 5G core including various 5G network functions, in accordance with various embodiments according to the present disclosure.

FIG. 2A illustrates an example communications system, in accordance with various embodiments according to the present disclosure.

FIG. 2B illustrates an example of the deployment automation device of FIG. 2A, in accordance with various embodiments according to the present disclosure.

FIGS. 3A-3D are flow diagrams illustrating example methods, in accordance with various embodiments of the present disclosure.

FIG. 4 illustrates an example computer system or computer device, in accordance with various embodiments of the present disclosure.

### DETAILED DESCRIPTION

The present disclosure provides solutions to addressing the above-mentioned challenges. One insight provided in the present disclosure is related to a cloud-agnostic CI/CD pipeline and orchestration framework/system (hereinafter “cloud-agnostic CI/CD system”) for deployment of applications (e.g., 5G network functions) on a target cloud platform and/or across different cloud platforms provided by different cloud providers. According to some embodiments, a method performed by the cloud-agnostic CI/CD system includes receiving an artifact associated with an application from a service vendor, extracting cloud-specific configuration parameters from the artifact, and standardizing the cloud-specific configuration parameters. The standardization may include, for example, selecting a cloud-agnostic configuration template containing predetermined standardized configuration parameters and mapping the cloud-specific configuration parameters to the standardized configuration parameters. The standardization may further include determining a reference configuration setting based on the cloud-agnostic configuration template and storing the reference configuration setting in a repository in the cloud-agnostic CI/CD system, which is used as a single source of truth during deployment and lifecycle management of the application. The method further includes generating an initial deployment script and executing the initial deployment script to deploy the application on the target cloud platform.

The cloud-agnostic approach for deploying applications across various cloud platforms provides advantages in terms of flexibility, adaptability, and reduced vendor lock-in. By utilizing standardized configuration templates, applications may be deployed on different cloud platforms without extensive modifications, which could simplify the deployment process, streamline management across diverse cloud platforms, and mitigate the challenges associated with vendor-specific configurations.

Another insight provided in the present disclosure is related to the cloud-agnostic CI/CD system used as a single source of truth through the deployment process of applications. The desired deployment state of the application can be stored in the cloud-agnostic CI/CD system as a reference point for both infrastructure and application configurations. The cloud-agnostic CI/CD system can monitor actual deployment state against this reference deployment state and allow for real-time detection/identification of configuration discrepancies, whether in the infrastructure, such as cluster configurations, or in the application, such as configuration parameters related to a specific instance of a deployed 5G network function. The cloud-agnostic CI/CD system can perform automated reconciliation processes to adapt to changes introduced by service vendors and facilitate the dynamic evolution of both infrastructure and application configurations across different cloud platforms.

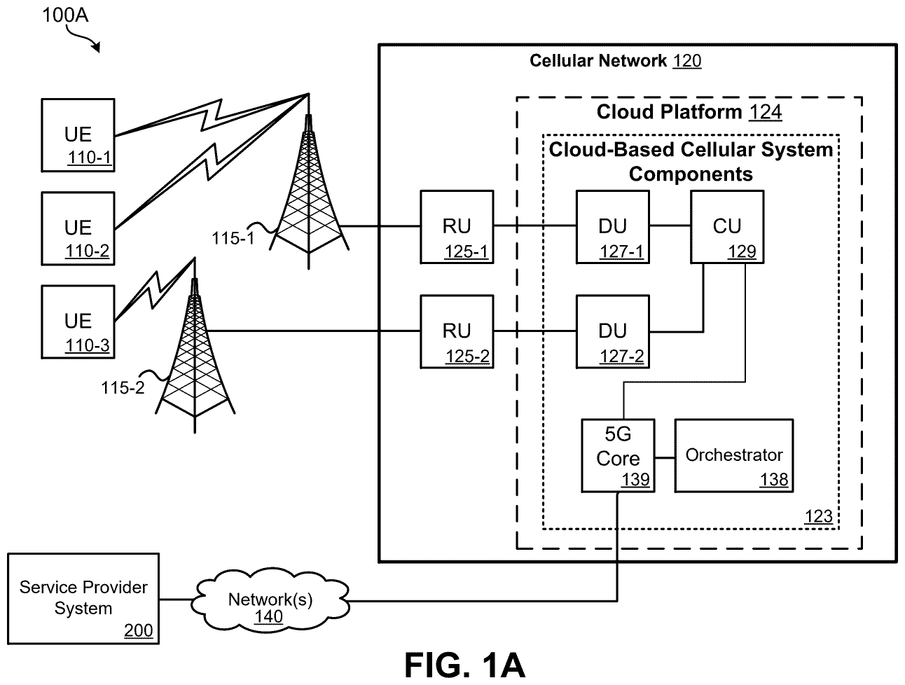

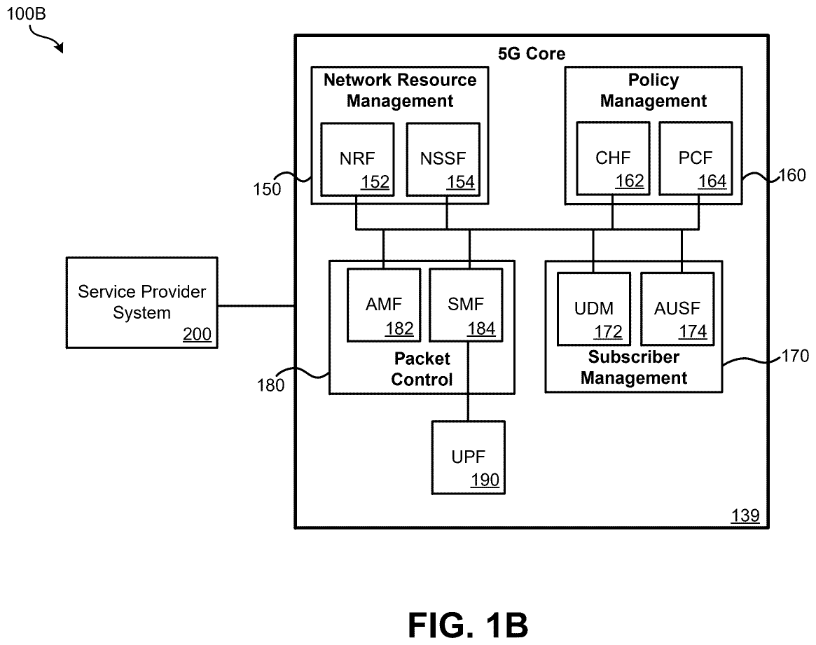

FIG. 1A illustrates an example of a cellular network system 100A (“system 100A”), in accordance with embodiments according to the present disclosure. System 100A can include a 5G New Radio (NR) cellular network; other types of cellular networks are also possible. System 100A can include user equipment 110 (UE 110, UE 110-1, UE 110-2, UE 110-3); base station 115; cellular network 120 infrastructure including hardware, software, switches, routers, etc.; cloud-based cellular system components 123 deployed on a cloud platform 124; radio units 125 (“RUs 125”); network 140; and service provider system 200. The cloud-based cellular system components 123 further include distributed units 127 (“DUs 127”); centralized unit 129 (“CU 129”); 5G core 139, and orchestrator 138. FIG. 1A represents a component level view. In an open radio access network (O-RAN), because components can be implemented as software in the cloud, except for components that need to receive and transmit RF, the functionality of the various components can be shifted among different servers to accommodate where the functionality of such components is needed.

UE 110 can represent various types of end-user devices, such as smartphones, cellular modems, cellular-enabled computerized devices, sensor devices, gaming devices, access points (APs), any computerized device capable of communicating via a cellular network, etc. Depending on the location of individual UEs, UE 110 may use RF to communicate with various base stations of cellular network 120. As illustrated, two base stations 115 (BS 115-1, 115-2) are illustrated. Real-world implementations of system 100A can include many (e.g., thousands) of base stations, RUs, DUs, and CUs. BS 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture.

One or more RUs, such as RU 125-1, may communicate with DU 127-1. One or more DUs, such as DU 127-1, may communicate with CU 129. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

5G core 139, which can be physically distributed across data centers or located at a central national data center (NDC), can perform various core functions of the network. 5G core 139 can include: authentication server function (AUSF); core access and mobility management function (AMF); data network (DN) which can provide access to various other networks; structured data storage network function (SDSF); and unstructured data storage network function (UDSF). Additional examples of the 5G core 139 are provided below with reference to FIG. 1B. While FIG. 1A illustrates various components of NDC and cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible O-RAN implementation, DUs 127, CU 129, 5G core 139, and orchestrator 138 can be implemented as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system.

Kubernetes, or some other container orchestration platform, can be used to create and destroy the logical DU, CU, 5G core units and subunits as needed for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed. (Rather, processing and storage capabilities of the data center would be devoted to the needed functions.) When the need for the logical DU or subcomponents of the DU is no longer needed, Kubernetes can allow for removal of the logical DU. Other examples of container orchestration platform include Docker Swarm, Apache Mesos, Elastic Container Service (ECS), Rancher, Nomad, OpenShift, and so on.

The orchestration, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Various embodiments may provide network slices, network services, or both. The network services provided may include VNFs (virtualized network functions), PNFs (physical network functions), and/or other network services. The VNFs may include software-based functions that may be utilized in conjunction with one or more slices such as security functions, monitoring functions, and/or the like. The PNFs may include hardware components of the cellular network which cellular network control system, which may include orchestrator 138, may configure to provide a network slice and/or other network services to a particular client.

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular network slices may only be reserved in particular geographic regions. For instance, a first set of network slices may be present at RU 125-1 and DU 127-1, a second set of network slices, which may only partially overlap or may be wholly different than the first set, may be reserved at RU 125-2 and DU 127-2. Further, particular cellular networks slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and be able to properly respond to changes in the network. In order to ensure not only the functionality and interoperability of such components, but also the ability to respond to changing network conditions and the ability to meet or perform above vendor specifications, significant testing must be performed.

Service provider systems 200 is in communication with the cellular network 120 via one or more networks 140 (e.g., Internet). The service provider systems 200 are operable to develop, test, and deploy services on the cellular network 120. In some embodiments, the service provider systems 200 may leverage a CI/CD pipeline framework for the deployment of 5G network functions on the cloud platform 124 for the cellular network 120.

FIG. 1B illustrates a block diagram of a cellular network core, which can represent 5G core 139. The 5G core 139 can be implemented on a cloud-computing platform. The 5G core 139 can be physically distributed across data centers, or located at a central national data center (NDC), and can perform various core functions of the cellular network. The 5G core 139 can include: network resource management components 150; policy management components 160; subscriber management components 170; and packet control components 180. Individual components may communicate on a bus, thus allowing various components of 5G core 139 to communicate with each other directly. The 5G core 139 is simplified to show some key components. Implementations can involve additional other components. Various components of the 5G core 139 may further include one or more 5G network functions (NFs).

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection- and session-related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) (e.g., the Internet) or various access networks. Access networks can include the RAN of cellular network 120 of FIG. 1A.

The network functions illustrated in FIG. 1B as part of 5G core 139 are merely exemplary. Many more or different network functions may be implemented in the cellular network core and may vary by slice. The amount of computing resources devoted to a particular function can vary by slice. The 5G core 139 is in communication with the service provider system 200. As mentioned above, the service provider system 200 can operate to develop, test, and deploy the network functions of the 5G core 139 on a cloud platform.

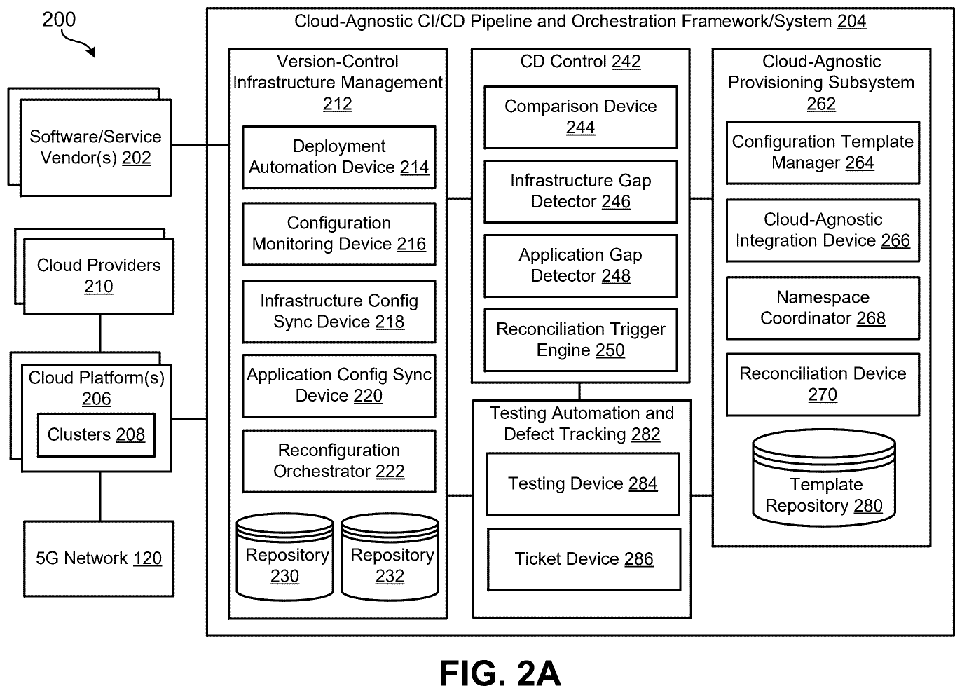

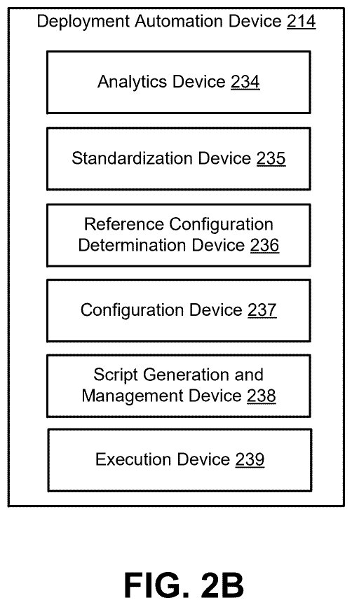

FIG. 2 is a block diagram illustrating an example service vendor system 200 for deployment of applications on a cloud platform according to various embodiments. In the illustrated example, the service provider system 200 includes, among other components, service vendor(s) 202, a cloud-agnostic CI/CD pipeline and orchestration framework/system 204 (hereinafter “CI/CD system 204”), and cloud platform(s)/environment(s) 206. The cloud platform 206 is in communication with the cloud-based cellular system 120 and further includes one or more clusters 208.

At a high level, service vendors 202 are entities or organizations that provide specific services, applications, or functionalities for deployment within the 5G network 120. The services may include 5G network functions (NFs) and applications executable on the 5G network 120. The CI/CD system 204 serves as the central coordination and automation hub for the CI/CD processes. Cloud platforms 206 represent the underlying infrastructure that hosts and executes the 5G network functions and applications. Cloud platforms 206 provide the necessary resources, such as computing power, storage, and networking, for deploying and running 5G network functions and applications. Clusters 208, sometimes also referred to as contain orchestration clusters, are specific instances or groups of computing resources within the cloud platforms 206. Clusters 208 serve as execution environments for deploying and running the 5G network functions and applications. Clusters 208 may be managed by container orchestration systems like Kubernetes to enhance scalability, manageability, and resource utilization. Communication channels connect the various components within the service provider system 200. For example, service vendor(s) 202 communicate service requirements and deliverables (e.g., source codes, artifacts, container images) to the CI/CD system 204. The CI/CD system 204 communicates deployment instructions to the cloud platforms 206 and their associated clusters 208. The cloud-agnostic nature of the CI/CD system 204 advantageously enables the seamless deployment of 5G network functions and applications across various cloud platforms 206 and empowers service vendors 202 to deploy 5G network functions and applications with agility and efficiency, irrespective of the specific cloud infrastructure in use.

In some embodiments, the cloud-agnostic CI/CD system 204 is a cloud-based service, for example, deployed on a management cluster such as Kubernetes cluster. The management cluster resides at the root of a hierarchy or tree of resources and is responsible for overseeing the overall deployment and management process across multiple clusters. While other clusters such as workload clusters that host 5G network function deployments may be created and managed by the cloud-agnostic CI/CD system 204, the management cluster remains the top-level orchestrator.

In some embodiments, the cluster 208 is a workload cluster managed by the management cluster. The workload cluster may also be a Kubernetes cluster but specifically designated to host and manage workloads, such as 5G network functions provided by service vendor 202.

In the illustrated example of FIG. 2, the CI/CD system 204 further includes, among other components, a version-control infrastructure management subsystem 212 (hereinafter “subsystem 212”), a CD control and management subsystem 242 (hereinafter “subsystem 242”), a cloud-agnostic provisioning subsystem 262 (hereinafter “subsystem 262”), and a testing automation and defect tracking subsystem 282 (hereinafter “subsystem 282”). Subsystem 212 further includes, among other components, deployment automation device 214, configuration monitoring device 216, infrastructure configuration synchronization device 218, application configuration synchronization device 220, reconfiguration orchestrator 222, and a version-controlled artifact repository 230, and a configuration repository 232. Subsystem 242 further includes, among other components, analytics/comparison device 244, infrastructure gap detector 246, application gap detector 248, reconciliation trigger device 250. Subsystem 262 further includes, among other components, configuration template manager 264, cloud-agnostic integration device 266, namespace coordinator 268, reconciliation device 270, and template repository 280. Subsystem 282 further includes, among other components, testing device 284 and ticket device 286. It should be noted that components from one subsystem, such as subsystem 212, may be incorporated into another subsystem, like subsystem 242, in alternative embodiments. In some embodiments, components included in different subsystems may exhibit similar functions and thus may be combined to form a single component. For example, the configuration monitoring device 216 might exhibit functional similarities with both the infrastructure gap detector 246 and the application gap detector 248. Accordingly, these components can be streamlined and consolidated into a unified component. Such flexibility allows for a modular and adaptable design, where components can be shared or reconfigured across different subsystems as needed.

Subsystem 212 is responsible for receiving packaged artifacts (hereinafter “artifacts”) of to-be-deployed 5G applications, services, and network functions, from service vendors 202. The received packaged artifacts are stored in the version-controlled repository 230. The packaged artifacts are the compiled, bundled, or packaged versions of the source code, or other relevant components that are ready for deployment. The artifacts may include executable binaries, container images, or any other form of deployable units. In some embodiments, subsystem 212 may expose an application programing interface (API) to the service vendor 202. The service vendor 202 may push the to-be-deployed artifacts to subsystem 212 through the exposed API.

The deployment automation device 214 in the subsystem 212 is responsible for handling the received artifacts and facilitate automated deployment of the received artifacts onto a target infrastructure (e.g., a set of workload clusters) of the cloud platform 206.

FIG. 2B illustrates an example of the deployment automation device 214. In the illustrated example, the deployment automation device 214 includes, among other components, an analytics device 234, a standardization device 235, a reference configuration determination device 236, a configuration device 237, a script generation and management device 238, and an execution device. The analytics device 234 is responsible for analyzing the received artifact and extract cloud-specific configuration parameters of the application. The analytics device 234 is also responsible for analyzing specification of the target cloud platform and identifying deployment requirements specific to the targe cloud platform. The deployment automation device 214 may further classify the configuration parameters into infrastructure configuration parameters, application configuration parameter, or hybrid configuration parameters related to both infrastructure and application.

The standardization device 235 is responsible for identifying a predetermined cloud-agnostic configuration template from a template repository (e.g., the template repository 280 of cloud-agnostic provisioning subsystem 262), identifying standardized configuration parameters included in the cloud-agnostic configuration template, and mapping the cloud-agnostic configuration parameters to the standardized configuration parameters, using a predetermined mapping mechanism (e.g., mapping logic or mapping rule stored in a rule database). The mapping process serves as a transformative step, converting cloud-specific configuration parameters into their standardized counterparts, thereby enhancing flexibility and reducing dependencies on specific cloud during the deployment process. In this way, the deployment becomes more adaptable and agnostic to the underlying cloud platform. The cloud-agnostic configuration template may be preestablished by subsystem 262.

The reference configuration determination device 236 is responsible for determining a reference configuration setting based on the cloud-agnostic configuration template as well as deployment requirements specific to the cloud platform. The reference configuration setting is aimed to achieve a desired deployment state (i.e., reference deployment state) of the application. In some embodiments, the reference configuration determination device 236 is responsible for calculate/determining reference values for each configuration parameters. In some embodiments, the reference configuration determination device 236 is responsible for generating a reference configuration file containing the standardized configuration parameters with the corresponding reference values and storing the reference configuration setting and the reference configuration file in a repository (e.g., configuration repository 232) used as a single source of truth during deployment and lifecycle management of the application.

The configuration device 237 is responsible for automatically applying the reference configuration setting to the cloud-agnostic configuration template or assigning the reference values to the standardized configuration parameters. The script generation and management device 238 is responsible for generating an initial deployment script containing the cloud-agnostic configuration template configured with the reference configuration setting for initial deployment of the application. The script generation and management device 238 is also responsible for updating/modifying the initial deployment script during a testing process or during actual deployment as needed. For example, the deployment script may be in YAML format and include configuration of both infrastructure and application. The deployment configuration corresponds to the infrastructure configuration parameters extracted from the received artifacts and defines the desired state for the deployment and specifies details such as the number of replicas, container image, and ports. The service/application configuration corresponds to the application configuration parameters extracted from the received artifacts and defines a service to expose the deployed application. The execution device 239 is responsible for executing the deployment script (e.g., the initial deployment script, an updated version of the initial deployment script, or new deployment script) during the testing deployment, actual deployment, as well as lifecycle management process.

The deployment automation device 214 may additionally perform one or more of the following operations on the received artifacts: performing verification and validation checks on the received artifacts to check whether they comply with the deployment requirements and standards, identifying and resolving dependencies within the received artifacts to check whether all necessary components and resources are available for deployment, determining the target infrastructure for deployment based on the specifications provided in the received artifacts, parsing the configuration details within the artifacts, implementing dynamic scaling mechanisms based on workload or demand, orchestrating the deployment process, coordinating the sequential or parallel execution of tasks, implementing error-handling mechanisms to identify and address any issues that may arise during the deployment process.

Now referring back to FIG. 2A, the configuration monitoring device 216 of subsystem 212 is operable to continuously monitor and compare the reference configuration setting with the deployed configuration setting of the deployed application. The reference configuration setting represents a reference deployment state, and the deployed configuration parameters represent an actual deployment state of the application. The configuration monitoring device 216 may further identify and report any discrepancies to facilitate real-time synchronization and maintain consistency of deployment. In some embodiments, the configuration monitoring device 216 continuously monitor the actual values of the standardized configuration parameters, compare the actual values against the reference values of the configuration parameters in real-time, identify any discrepancies between the reference values and the actual values, and report the identified discrepancies to the deployment automation device 214.

As mentioned above, the standardized configuration parameters may further include infrastructure configuration parameters and application configuration parameters. Examples of the infrastructure configuration parameters include but are not limited to cluster specifications (e.g., number of nodes, resource allocation), network configurations (e.g., IP addresses, subnets, routing rules), cloud provider-specific settings (e.g., storage configurations, load balancer settings), security settings (e.g., access controls, firewall rules), declarative definitions for resources (e.g., databases, virtual machines). Examples of the application configuration parameters include but are not limited to 5G network function (NF) settings (e.g., AMF, SMF, UPF configurations), resource allocation for specific NF instances (e.g., CPU, memory), service discovery and communication configurations, environmental parameters (e.g., development, testing, production), dependencies and integration points with other applications or services.

The deployment automation device 214, upon receiving the reported discrepancies, triggers synchronization processes to rectify the identified inconsistencies (e.g., infrastructure configuration inconsistencies and application configuration inconsistencies). In some embodiments, the deployment automation device 214 triggers the infrastructure configuration synchronization device 218 and application configuration synchronization device 220 to perform the synchronization processes.

The infrastructure configuration synchronization device 218, once triggered by the deployment automation device 214, may execute one or more synchronization processes to rectify the identified infrastructure configuration inconsistencies. In some embodiments, the infrastructure configuration synchronization device 218 may dynamically modify the initial deployment scripts and/or generate a new deployment script, based on the identified discrepancies (i.e., the difference between the actual values and predetermined values of the configuration parameters), substitute outdated or incorrect values in the deployment scripts with the desired values, update reference values, deploy the modified/updated deployment scripts, and perform real-time synchronization to maintain consistency between version-controlled and deployed configurations.

As mentioned above, infrastructure configuration inconsistency used herein refers to variations between the actual values of infrastructure configuration parameters and their reference (desired) values. Examples of infrastructure configuration inconsistencies may include resource allocation discrepancy, network configuration mismatch, storage capacity difference, instance type discrepancy, security group configuration issue, region or location difference, and so on. For example, a resource allocation discrepancy may be identified when an actual value representing the actual number of CPU resources allocated for the deployed infrastructure is different from the predetermined value representing the desired number of CPU resources specified in the artifact provided by the service vendor 202, or when the difference therebetween exceeds a predetermined threshold level. A network configuration mismatch is identified when the actual value representing the IP addresses used in the deployed network configuration are different from the predetermined value specified in the artifact by the service vendor.

Similarly, the application configuration synchronization device 220, once triggered by the deployment automation device 214, may execute one or more synchronization processes to rectify the identified application configuration inconsistencies. In some embodiments, the application configuration synchronization device 220 may dynamically modify the initial deployment scripts and/or generate a new deployment script, based on the identified discrepancies, substitute outdated or incorrect values in the deployment scripts with the desired values, update reference values of the application configuration parameters, deploy the modified/updated deployment scripts, and perform real-time synchronization to maintain consistency between version-controlled and deployed configurations.

As mentioned above, application configuration inconsistency used herein refers to variations between the actual values of application configuration parameters and their reference (desired) values. Examples of application configuration parameters prone to inconsistency include network function configuration discrepancy, resource allocation discrepancy for NF instance, service discovery configuration discrepancy, testing configuration discrepancy, and so on. For example, a network function configuration discrepancy may be identified when the actual value representing a network function (e.g., AMF) configured with an actual number of concurrent connections is different from a reference value representing the desired or intended number of concurrent connections extracted from the artifact provided by the service vendor. A resource allocation discrepancy for NF instance may be identified when the actual value representing a current number of resources (e.g., number of CPU and memory) allocated to a specific network function instance is different from a reference value representing the desired number of resources allocated to the specific network function instance extracted from the artifact provided by the service vendor 202.

The version-controlled repository 230 is used to store the received artifact. The artifacts received from the service vendor may be automatically converted to Infrastructure-as-Code (IaC) artifacts using IaC languages to define the reference or desired state of the deployment. Metadata related to the versioning of the stored artifacts used for tracking changes, managing versions, and facilitating collaboration among development and operations teams may also be stored in repository 230.

The configuration repository 232 stores the reference configuration setting as well as other configuration files that are used to determine the reference deployment state of the application. The configuration repository 232 is used as a single source of truth during the deployment and lifecycle management of the application. Examples of IaC languages are Terraform scripts, CloudFormation templates, or Ansible playbooks. The reference configuration files containing reference configuration settings including infrastructure configurations, application configurations, and environment-specific settings are also stored in the configuration repository 232. The deployment requirements specific to the cloud platforms are also stored in the configuration repository 232. The reference configuration settings may be updated according to the update of the artifact and/or deployment requirements specific to the cloud platform.

The reconfiguration orchestrator 222 is responsible for coordinating the various tasks involved in the reconfiguration of both infrastructure and application configuration parameters. The reconfiguration orchestrator 222 may communicate with other components within the subsystem 212, such as deployment automation device 214, infrastructure configuration synchronization device 218 and application configuration synchronization device 220 in operation to facilitate a coherent and synchronized reconfiguration across both infrastructure and application layers. The reconfiguration orchestrator 222 may determine the priority of reconfiguration tasks based on factors such as criticality, dependencies, or specific requirements specified in the received artifacts, scheduling the timing of reconfiguration activities to minimize disruption and align with any predefined maintenance windows or operational considerations.

In some embodiments, the reconfiguration orchestrator 222 may initiate a rollback mechanism. The rollback mechanism used herein refers to the automated process of reverting deployed changes to a previous, known, and stable state when issues or inconsistencies are detected in the newly deployed version. In some embodiments, performing a rollback mechanism further includes monitoring key performance indicators (KPIs) and metrics after reconfiguration, automatically detecting and recognizing anomalies when observed metrics exceeds a predetermined threshold, making a rollback decision based on predefined criteria, initiating the rollback mechanism to revert the deployment to a previous stable version, retrieving the previously deployed artifact containing the last known stable version of the application or infrastructure configuration, reapplying configuration settings from the retrieved artifact to restore the system to its previous state, and performing automated or manual validation and testing procedures post-rollback to determine whether the observed metrics are below the predetermined threshold. Examples of the KPIs and metrics include but are not limited to deployment success rate, mean time to recovery (MTTR), deployment frequency, error rate, downtime, infrastructure utilization, response time, rollback frequency, and so on. In some embodiments, the reconciliation device 270 of subsystem 262 may also be operable to initiate a rollback mechanism in a similar manner as described above.

Subsystem 242 is responsible for monitoring, analyzing, and initiating corrective actions based on the deployment process and the deployment state of the deployed application. Subsystem 242 receives information of the deployment including analytics, infrastructure status, and application configurations, compares the actual state of the deployed application with reference state predetermined by the configurations managed by subsystem 212, and perform reconciliation to ensure consistency between the reference state and the actual state.

Subsystem 242 collects data related to the deployment process, including metrics, logs, and performance indicators to gain insights into the overall health and efficiency of the deployment. Deployment information includes infrastructure status information about the clusters, nodes, and other components that constitute the deployed environment as well as application status information about 5G network functions, resource allocations, and other settings for the functionality of the application or service.

The analytics/comparison device 244 is responsible for processing the collected deployment data obtained during the deployment process, determining an actual deployment state (e.g., an actual stability level) from the collected deployment data, comparing the obtained deployment data and the actual deployment state with a predetermined reference deployment state representing expected values, and determining a difference between the actual deployment state and the predetermined state. The deployment state is quantitatively or semi-quantitatively characterized by values associated with the configuration parameters representing specific metrics related to resource utilization, response times, error rates, and other performance indicators for indicating the health and stability of the deployed application. In some embodiments, the reference deployment state may be obtained from historical deployment data and/or determined by the received artifacts.

The infrastructure gap detector 246 is responsible for determining whether the identified gap (or difference) between the actual and reference deployment state is related to, associated with, or caused by an infrastructure configuration discrepancy. Similarly, the application gap detector 248 is responsible for determining whether the identified gap between the actual and reference deployment state is related to, associated with, or caused by an application configuration discrepancy. In some embodiments, the identified gap between the actual and reference deployment state may be related to both an infrastructure configuration discrepancy and an application configuration discrepancy.

In some embodiments, the infrastructure gap detector 246 may receive information about the identified gap between the actual and reference deployment state and analyze the deployment data associated with the identified gap, focusing on information related to infrastructure components. In some embodiments, the infrastructure gap detector 246 query an infrastructure configuration repository (e.g., included in the repository 230) to retrieve the predetermined infrastructure configuration, compare the actual configuration extracted from the deployment data with the predetermined infrastructure configuration, determine specific discrepancies or differences in the infrastructure configuration parameters, determine whether the identified infrastructure discrepancies exceeds the predetermined threshold, generate an infrastructure gap report describing the nature and extent of the infrastructure configuration discrepancies.

Likewise, the application gap detector 248 may receive information about the identified gap between the actual and reference deployment state and analyze the deployment data associated with the identified gap, focusing on information related to application components. In some embodiments, the application gap detector 248 query an application configuration repository (e.g., included in the repository 230) to retrieve the predetermined application configuration, compare the actual configuration extracted from the deployment data with the predetermined application configuration, determine specific discrepancies or differences in the application configuration parameters, determine whether the identified application discrepancies exceeds the predetermined threshold, generate an application gap report describing the nature and extent of the infrastructure configuration discrepancies.

In some embodiments, the infrastructure gap detector 246 and the application gap detector 248 may operate in a collaborated manner to simultaneously determine that the identified gap is related to both infrastructure and application discrepancies. For example, the infrastructure gap detector 246 and the application gap detector 248 may receive information about the identified gap between the actual and reference deployment state, correlate infrastructure data, such as cluster settings and node configurations, with application data, including 5G network function settings and resource allocations, perform an integrated query to the infrastructure configuration repository and application configuration repository (e.g., included in repository 230) to retrieve both the predetermined infrastructure and application configurations, simultaneously compare the actual configurations extracted from the deployment data with the predetermined infrastructure and application configurations, identify specific discrepancies or differences in both infrastructure and application configuration parameters and identify areas where the actual deployment deviates from the expected state, cross-verify whether the identified discrepancies, both in infrastructure and application, collectively exceed predetermined thresholds, and generate a gap report describing the nature and extent of both infrastructure and application configuration discrepancies. In some embodiments, the infrastructure gap detector 246 and the application gap detector 248 may collaboratively determine a weight of each of the infrastructure and application configuration discrepancies contributing to the identified gap of the actual and reference deployment state.

The reconciliation trigger device 250 is responsible for initiating reconciliation processes based on identified discrepancies between the actual deployment state and the reference deployment state. The reconciliation trigger device 250 may prioritize the identified and verified discrepancies based on predefined criteria, determine appropriate reconciliation triggers, and initiate synchronization processes. In some embodiments, the reconciliation trigger device 250 may trigger the reconciliation device 270 of subsystem 262 to perform the reconciliation processes.

The subsystem 262 is responsible for generating and managing configuration templates, facilitating cloud-agnostic integration, coordinating namespaces, performing reconciliation, and maintaining a repository of templates. Configuration template manager 264 is responsible for generating configuration templates (e.g., a Crossplane composition resource template) and resource declarations or claims (e.g., Crossplane claims), storing the generated configuration templates and the resource claims in the template repository 280, managing the generated configuration templates, and facilitating organizing, structing, versioning, storing, and retrieving the configuration templates.

The Crossplane composition resource template represents a template for creating multiple managed resources as a single object with a focus on the composition and configuration of underlying infrastructure components and therefore can be considered an infrastructure configuration template. A Crossplane claim used herein is a declarative specification that defines the desired state of a particular cloud or infrastructure resource within the CI/CD system 204. a Crossplane claim may serve as a configuration document that contains the application parameters needed to instantiate and configure a specific resource, such as a database, virtual machine, or other cloud services. The Crossplane claims may be integrated to a cloud-agnostic configuration template, abstract away cloud-specific details, and provide a standardized, cloud-agnostic representation of how a particular resource should be provisioned and configured.

In some embodiments, the configuration template manager 264 may perform tasks related to generating cloud-agnostic configuration templates. For example, the configuration template manager 264 may identify the infrastructure components necessary for deployment, including computing resources, storage, and networking, employ IaC principles to define the infrastructure using a declarative language, such as YAML, JSON, SQL, CSS, etc., to express the desired infrastructure state, perform a parameterization process to make configuration templates adaptable to different environments. Variables or parameters are introduced as placeholders for values that can change based on the target cloud platform or environment. Variables are defined to capture cloud-specific details like region, instance types, storage options, etc. the configuration template manager 264 may further abstract configurations related to applications or services, such as container orchestration settings or database configurations, to create a more generalized and adaptable configuration template. The configuration template manager 264 stores the generated cloud-agnostic configuration templates in the template repository 280 for future reference and use. In some embodiments, the configuration template manager 264 may analyze historical deployment scripts to identify aspects that may vary across different cloud platforms or environments. Variables or parameters are introduced to represent these aspects, facilitating adaptability. The configuration template manager 264 may also perform testing of the parameterized configuration templates across diverse cloud platforms or environments to verify that the configuration templates can successfully adapt to varying conditions without necessitating extensive modifications.

As mentioned above, subsystem 212 can leverage the cloud-agnostic configuration templates when generating deployment scripts in the initial deployment when receiving to-be-deployed artifacts from service vendor 202. The deployment script, which is specific to the target cloud environment, is generated by integrating the cloud-specific configuration parameters into these configuration templates. The deployment script aligns with the requirements and capabilities of the chosen cloud provider and enables the CI/CD system 204 to deploy the same set of artifacts across various cloud platforms with differing infrastructures.

The cloud-agnostic integration device 266 is responsible for facilitating integration and communication between subsystem 262 and various cloud platforms/environments 206. The cloud-agnostic integration device 266 may abstract the cloud-specific details and APIs of different cloud providers 210 to allow the CI/CD system 204 to interact with cloud providers 210 in a standardized, cloud-agnostic manner. The cloud-agnostic integration device 266 enables the CI/CD system 204 to deploy and manage applications across diverse cloud platforms without being tightly coupled to any particular cloud provider 210. In some embodiments, the cloud-agnostic integration device 266 facilitates interfacing with the API of the target cloud provider 210 during the deployment of applications or services on the cloud platform 206 provided by the target cloud provider. This allows the service vendor 202 to engage solely with the API of the CI/CD system 204 for deploying the same application across diverse cloud platforms provided by different cloud providers 210. The cloud-agnostic integration device 266 acts as an intermediary, abstracting the intricacies of various cloud provider APIs, thereby sparing the service vendor from the need to directly interface with distinct APIs of different cloud providers 210. This abstraction layer enhances operational simplicity, provides a uniform deployment experience, and promote interoperability across varied cloud environments.

The namespace coordinator 268 is responsible for orchestrating the allocation and management of namespaces within the target cloud platform 206 or cluster 208 during the deployment of applications or services. The namespace coordinator 268 may dynamically create, manage, and organize namespaces based on the deployment requirements specified in the received artifacts or configurations for maintaining a structured and isolated environment and enabling deployment and management of applications in a cloud-agnostic manner. For example, applications or services can be deployed across different cloud platforms, each with its own cluster. The namespace coordinator 268 may analyze the context of the cloud provider 210 specified in the deployment request and identify the specific cluster details and namespace requirements associated with the cluster 208, create or select a namespace within the target cluster 208 based on the identified cloud provider context, such that the selected namespace adheres to the cluster specifications and is compatible with the cloud platform 206, coordinate the naming conventions or adjustments needed for the selected namespace to align with a predetermined cloud-agnostic rule, and communicate the selected or created namespace information to other components involved in the deployment process.

As mentioned above, once triggered by the reconciliation trigger device 250, the reconciliation device 270 may perform a reconciliation process to rectify the identified gap between the actual and reference deployment state. The reconciliation device 270 may analyze the cloud-agnostic configuration templates along with the reference configuration file applied to the deployment script, to determine one or more actions needed to bring the actual deployment state in alignment with the reference deployment state. In some embodiments, the actions may include creating, updating, or deleting resources within the clusters 208. The reconciliation device 270 may operate in a collaborative or conjunctive manner with other components of the CI/CD system 204 (e.g., the deployment automation device 214, infrastructure configuration synchronization device 218, application configuration synchronization device 220, and reconfiguration orchestrator 222 to execute the determined actions.

The template repository 280 stores infrastructure configuration templates and application configuration templates, and other templates used in the cloud-agnostic deployment process. The template repository 280 may also implement version control mechanisms to track changes and updates to templates over time. During the deployment process, subsystem 212, 242, and 262, or any components thereof may retrieve the necessary templates from the template repository 280.

Subsystem 282 is responsible for managing the testing processes, automating test scenarios, reporting defects. In some embodiments, subsystem 282 is also responsible for automatic creation of Jira tickets based on test results. In some embodiments, the testing device 284 may generate a testing environment that simulates the actual production environment of the target cloud platform, executes one or more test case to test the to-be-deployed services and applications (e.g., 5G network functions) in the testing environment, and orchestrate the testing processes in an automated manner. Testing device 284 can gather and analyze test results and provide feedback on the performance and reliability of the applications or services under test. The applications or services can be deployed in a production environment of the target cloud platform. The ticket device 286 is generally responsible for managing and tracking issues, defects, and tasks related to the testing process. The ticket device 286 may create and update tickets (e.g., Jira tickets) based on the outcomes of testing processes, automatically generate tickets for identified defects with detailed information about the issues, steps to reproduce, and associated test results. The ticket device 286 may also support the integration of testing information into the broader development workflow and facilitate communication and issue resolution.

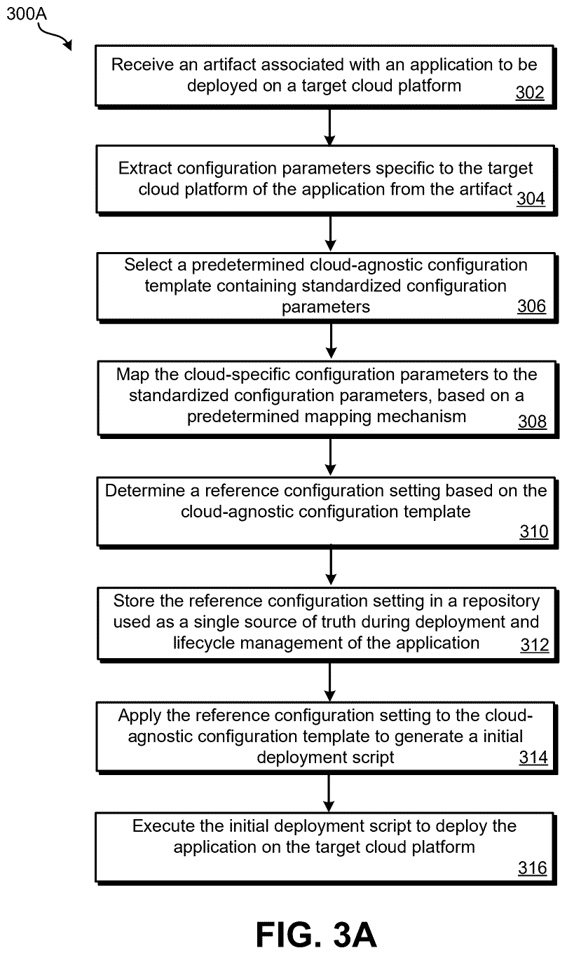

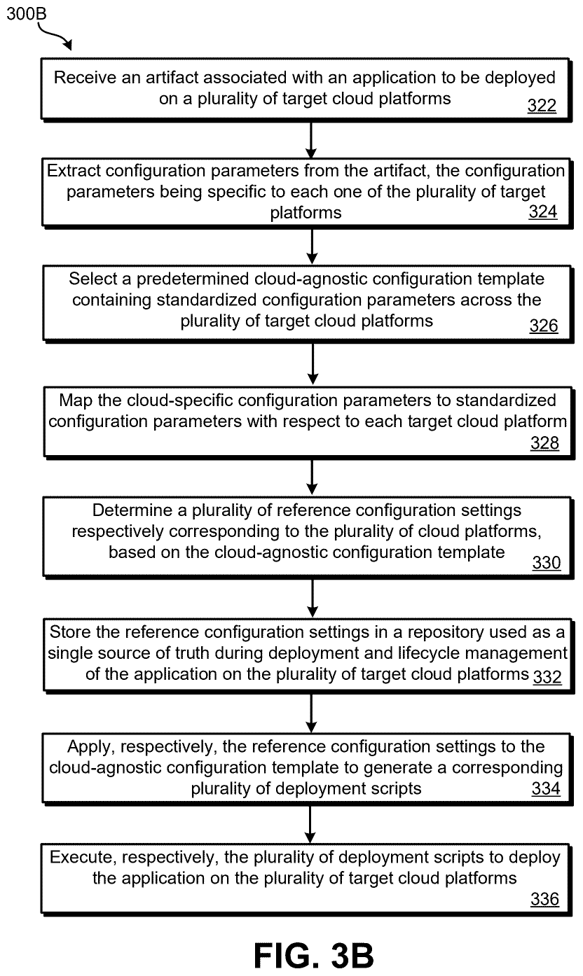

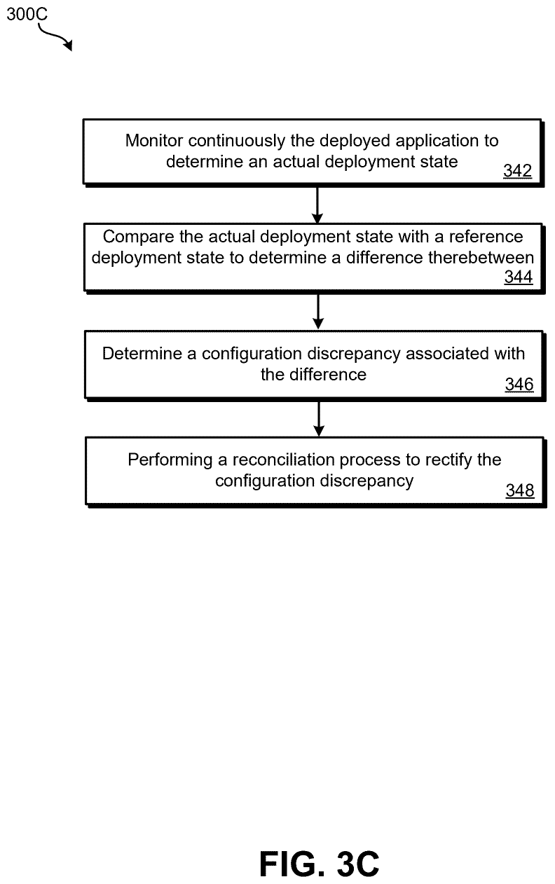

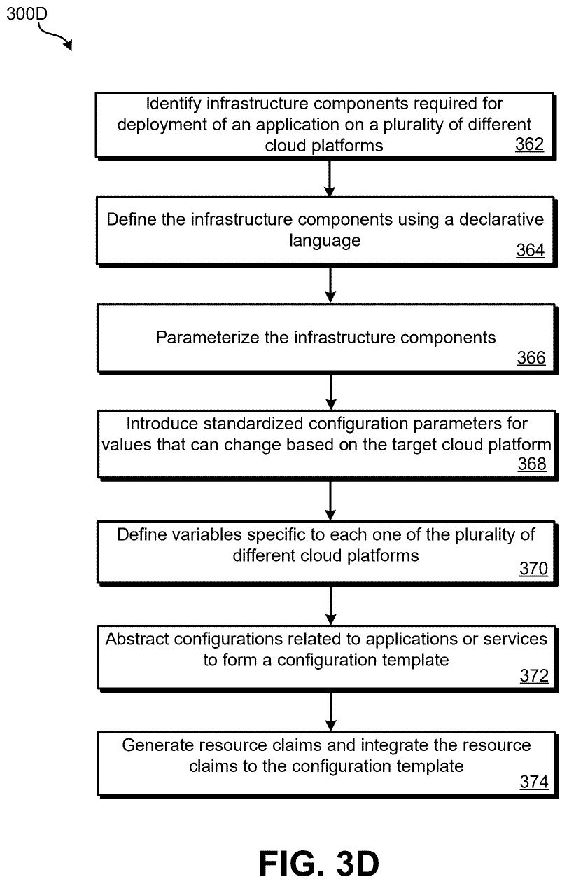

FIGS. 3A, 3B, and 3C are flow diagrams respectively illustrating example methods 300A, 300B, and 300C for deploying applications or services provided by service vendors on a target cloud platform provided by a cloud provider using the cloud-agnostic CI/CD system, according to various embodiments. Each one of the methods 300A, 300B, and 300C may include one or more operations/steps. Few or additional operations/steps may be included. The operations of one method may be combined with operations of another method in a suitable manner.

Now referring to FIG. 3A, method 300A will be described. At 302, an artifact associated with an application to be deployed on a target cloud platform is received in a cloud-agnostic CI/CD pipeline and orchestration framework/system (e.g., the CI/CD system 204). In some embodiments, the application is a 5G network function. The artifact may be an executable binary, a container image, or other deployable unit. The received artifact may be stored in a version-controlled repository. In some embodiments, an API is exposed to the service vendor and the artifact is received through the API. The cloud-agnostic CI/CD system is used as a single source of truth.

At 304, the artifact is analyzed by the CI/CD system, and cloud-specific configuration parameters of the application are extracted from the artifact. The configuration parameters are specific to the target cloud platform may include infrastructure configuration parameters and application configuration parameters. The infrastructure configuration parameters pertain to the settings and specifications necessary for configuring the underlying infrastructure required by the application. Examples of the infrastructure configuration parameters include cluster specifications (e.g., number of nodes, resource allocation), network configurations (e.g., IP addresses, subnets, routing rules), storage settings (e.g., storage configurations, load balancer settings), security settings (e.g., access controls, firewall rules), and definitions for cloud resources (e.g., databases, virtual machines). The application configuration parameters pertain to the to-be-deployed application and may include 5G network function (NF) settings (e.g., AMF, SMF, UPF configurations), resource allocation for specific NF instances (e.g., CPU, memory), service discovery and communication configurations, environmental parameters (e.g., development, testing, production), and dependencies and integration points with other applications or services. The cloud-specific configuration parameters may further include parameters related to both infrastructure and application, such as scaling configuration parameter specifying auto-scaling policies, instance counts, load balancing, service discovery.

At 306, a predetermined cloud-agnostic configuration template containing standardized configuration parameters is selected. The predetermined cloud-agnostic configuration template may be stored in a template repository of the CI/CD system and retrieved therefrom. The predetermined cloud-agnostic configuration template contains a standardized configuration setting that is uniform across various cloud platforms and cloud providers. The standardized configuration setting contains a plurality of standardized configuration parameters.

At 308, the cloud-specific configuration parameters extracted from the artifact are mapped to the standardized configuration parameters from the predetermined cloud-agnostic configuration template, based on predetermined mapping mechanisms. The cloud-specific infrastructure configuration parameters and application configuration parameters may be respectively mapped to standardized infrastructure configuration parameters and application configuration parameters of the cloud-agnostic configuration template. In some embodiments, the mapping mechanism may include using a set of resource claims (e.g., Crossplane claims described herein). The resource claims are written in declarative languages and essentially abstract the cloud-specific details and provide a standardized way to express the desired state of resources across different cloud platforms. For example, a cloud-specific configuration parameter may be “Cloud A: “region: us-east-1, instanceType: t2.micro.” The standardized parameter in a Crossplane claim form may be “provider: aws, region: us-east-1, instanceType: t2.micro.” The mapping mechanism, in this example, includes using a Crossplane claim to define how the cloud-specific parameters align with the standardized parameters. This Crossplane claim can then be applied to the cloud-agnostic configuration template to allow for a consistent and abstracted representation of resources that can be deployed across different cloud platforms.

In another example, a cloud-specific application configuration parameter named “cloud_instance_count” specifies the number of instances of the 5G NF to be deployed in the cloud platform and is specific to the cloud provider's deployment specifications. A standardized configuration parameter named “standard_instance_count” used in the cloud-agnostic template specifies the desired number of instances for the 5G NF in a way that is not coupled to any specific cloud provider. A predetermined mapping mechanism is used to transform or map the “cloud_instance_count” to the “standard_instance_count.” Optionally, the mapping mechanism may further require adding a constant value to align with the desired “standard_instance_count.” For example, the mapping mechanism may specify that “standard_instance_count=cloud_instance_count+adjustment_constant.” The adjustment constant is determined based on the understanding of the differences in how various cloud providers represent or configure certain parameters, for example, by testing and observation, empirical data, cloud provider documentation, historical data, etc. Regardless of the specific cloud provider, the standardized configuration parameter for the instance count is derived consistently based on the cloud-specific application configuration parameter.

At 310, a reference configuration setting is determined based on the cloud-agnostic configuration template. In some embodiments, deployment requirements specific to the target cloud platform are identified. The deployment requirements specific to the target cloud platform may be identified based on the artifact or other sources of the target cloud platform. For example, unique characteristics, features, attributes, and specification of the clusters/infrastructure of the target cloud platform may be obtained from the associated cloud provider. In some embodiments, the deployment requirements may also include the choice of cloud region, data center, specific environment settings within the chosen cloud platform, the appropriate virtual machine sizes, CPU and memory specifications, IP addresses or IP pools, portals, subnets, routing rules, and any specific networking features, access controls, firewall rules, and encryption requirements. The reference configuration setting is determined by the specification of the artifact as well as the deployment requirement specific to the cloud platform. In some embodiments, a reference values or a range of reference values for each standardized configuration parameter of the cloud-agnostic configuration template is also determined.

At 312, the reference configuration setting and the reference values are stored in a configuration repository of the CI/CD system. The configuration repository is used as a single source of truth during deployment and lifecycle management of the application. In some embodiments, a reference configuration file is generated to encompass the reference configuration setting. The reference configuration file is subject to change, for example, upon change of the artifact, update of the artifact version, change of deployment requirement, etc.

At 314, the reference configuration setting is applied to the cloud-agnostic configuration template for the initial deployment of the application. In some embodiments, the reference values are assigned to the standardized configuration parameters of the cloud-agnostic configuration template as initial values. In some embodiments, an initial deployment script is generated based on the cloud-agnostic configuration template configured with the initial values.

At 316, the initial deployment script is executed to initiate deployment of the application on the target cloud platform. Once the application is deployed, the actual values of the standardized configuration parameters may change in the dynamic and evolving cloud environment and may deviate from the initial values. In some embodiments, the application is deployed in a testing environment that simulates the production environment of the target cloud platform before actual deployment on the target cloud platform. The reference configuration setting and reference values may be further optimized or adjusted during the testing process until an optimal and stable deployment state is obtained from the testing result.

Now referring to FIG. 3B, method 300B is a close variation of method 300A. Similar to method 300A, method 300B may be performed by the cloud-agnostic CI/CD system. Method 300B may be used for deployment of an application across different cloud platforms provided by different cloud providers through use of a cloud-agnostic configuration template. Various operations of method 300B similar to method 300A will be not repeated unless otherwise indicated.

At 322, an artifact associated with an application to be deployed on a plurality of target cloud platforms is received in the cloud-agnostic CI/CD system. The plurality of target cloud platforms may be different from each other and/or provided by different cloud providers. At 324, configuration parameters of the application specific to each one of the plurality of target platforms are extracted from the artifact. The configuration parameters may include infrastructure configuration parameters and application configuration parameters.

At 326, a predetermined cloud-agnostic configuration template containing standardized configuration parameters across the plurality of target cloud platforms. At 328, the cloud-specific configuration parameters are mapped to standardized parameters with respect to each target cloud platform. A set of resource claims (e.g., Crossplane claims defining the resources for each target cloud platform using a declarative language) may be used as a mapping mechanism for mapping the parameters. At 330, a plurality of reference configuration settings is determined respectively corresponding to the plurality of cloud platforms, based on the cloud-agnostic configuration template as well as deployment requirements specific to each target cloud platform. At 332, the plurality of reference configuration settings is stored in a repository used as a single source of truth during deployment and lifecycle management of the application on the plurality of target cloud platforms.

At 334, the plurality of reference configuration settings is respectively applied to the cloud-agnostic configuration template to generate a corresponding plurality of deployment scripts. At 336, the plurality of deployment scripts is respectively executed to deploy the application on the corresponding plurality of target cloud platforms. In some embodiments, the application is deployed in a testing environment that simulates the production environment of each target cloud platform before actual deployment on the target cloud platform. The reference configuration setting and reference values may be further optimized. Implementation of method 300B can allow a service vendor to deploy an application or a set of applications of similar functions across multiple different cloud platforms using the cloud-agnostic CI/CD system described herein without the need to individually interact each cloud provider.

Now referring to FIG. 3C, method 300C will be described. At 342, where the deployed application on a target cloud platform is continuously monitored by the cloud-agnostic CI/CD system. In some embodiments, an actual deployment state of the application is monitored against a reference or standard deployment state. The reference deployment state is predetermined based on the reference values of the configuration parameters or the reference configuration setting determined by the CI/CD system and used as the single source of truth. The real-time actual deployment state is determined based on the actual values of the configuration parameters after the application is deployed on the target cloud platform.

At 344, the actual deployment state is compared with the reference deployment state to determine a difference therebetween. In some embodiments, a deployment stability level or score representing the deployment state is calculated based on a predetermined algorithm. For example, a difference between a reference deployment stability score and an actual deployment stability score is continuously monitored.

At 346, a configuration discrepancy associated with the difference is determined. In some embodiments, when the difference between the actual deployment state and the reference deployment state exceeds a predetermined threshold, one or more configuration discrepancies are identified. A configuration discrepancy used herein refers to a difference of a predetermined reference value and an actual value of a configuration parameter or a group of configuration parameters. The configuration discrepancy may be an infrastructure configuration discrepancy (i.e., related to infrastructure configuration parameters), an application configuration discrepancy (i.e., related to application configuration parameters), or a combined infrastructure and application configuration discrepancy (i.e., related to both infrastructure and application configuration parameters).

At 348, a reconciliation process is performed to rectify the configuration discrepancy. The reconciliation process may include an infrastructure synchronization process to rectify the infrastructure configuration discrepancy, an application synchronization process to rectify the application configuration discrepancy, or both.

In one example use case implementing method 300C, a cluster configuration is specified in the cloud-agnostic CI/CD system as part of the reference deployment state. This configuration includes parameters such as the number of nodes, resource allocation, and network settings. The corresponding predetermined values for these parameters are defined in the cloud-agnostic CI/CD system based on the artifact received from the service vendor as well as deployment requirement specific to the cloud platform. During the actual deployment, the deployed cluster is monitored by the cloud-agnostic CI/CD system in the target cloud environment and compares the actual values of the configuration parameters (e.g., the current number of nodes, resource allocation, and network settings) with the predetermined reference values. If the difference between the actual deployment state and the reference deployment state exceeds a predetermined threshold, an infrastructure configuration discrepancy is indicated. For example, if the deployed cluster has a different number of nodes or resource allocation than what was specified in the cloud-agnostic CI/CD system, this would be identified as an infrastructure configuration discrepancy. A reconciliation process then can be initiated by the cloud-agnostic CI/CD system to rectify the identified infrastructure discrepancies, such as updating the initial deployment script, assigning new values of the configuration parameter, changing reference values, etc.

In another example use case implementing method 300C, a 5G network function (NF) is deployed in a Kubernetes cluster hosted in a cloud environment. The deployed 5G network function is monitored by the cloud-agnostic CI/CD system. The reference deployment state is determined by the cloud-agnostic CI/CD system based on the artifact received from the service vendor as well as the deployment requirement specific to the cloud platform. The reference deployment state may include application configuration parameters for the 5G network function, such as the number of instances, resource allocation, and specific parameters related to the 5G network function. During the monitoring process, the actual deployment state of the 5G network function is compared with the predetermined reference state specified in the cloud-agnostic CI/CD system. After the initial deployment, a new instance or new parameters for an already deployed NF are added/introduced according to a new requirement by the service vendor and/or the cloud platform. If these changes are not reflected in the reference deployment state, it would be identified by the cloud-agnostic CI/CD system as an application configuration discrepancy. In response to the discrepancy, a reconciliation process is performed by the cloud-agnostic CI/CD system. The reference values of the application configuration parameters of the 5G network function may be updated. An application configuration synchronization process may be performed by the cloud-agnostic CI/CD system to reconfigure the application configuration parameters related to the 5G network function in the target Kubernetes cluster on the cloud platform based on the updated application configuration parameters. The actual deployment state (5G network function in the cloud) is brought in line with the reference deployment state stored in the cloud-agnostic CI/CD platform (e.g., repository as the single source of truth) to accommodate any new NF instances or parameters introduced by the service provider.

FIGS. 3D is a flow diagram illustrating an example method 300D for generating a cloud-agnostic configuration template using the cloud-agnostic CI/CD system (e.g., the configuration template manager 264 of the CI/CD system 204), according to various embodiments. Few or additional operations/steps may be included in method 300D. Method 300D or any operations/steps thereof may be combined with operations of other methods described herein in a suitable manner.

At 362, infrastructure components (e.g., resources) required for deployment of an application on a plurality of different cloud platforms are identified. At 364, the infrastructure components are defined using a declarative language. At 366, the infrastructure components are parameterized to generate infrastructure configuration parameters. At 368, standardized configuration parameters are introduced as placeholders for values that can change across the plurality of cloud platforms. The standardized infrastructure configuration parameters are designed to remain consistent across the plurality of different cloud platforms and represent values that are subject to change but are standardized among the multiple cloud platforms with a high degree of uniformity. At 370, variables specific to each one of the plurality of different cloud platforms are defined. The specific variables represent details that are specific to each cloud platform, such as availability zone, data center selection, service endpoint URLs, etc. At 372, configuration parameters related to applications or services are abstracted from the cloud-agnostic configuration template. At 374, resource declarations or claims (e.g., Crossplane claims) are generated and integrated to the configuration template.

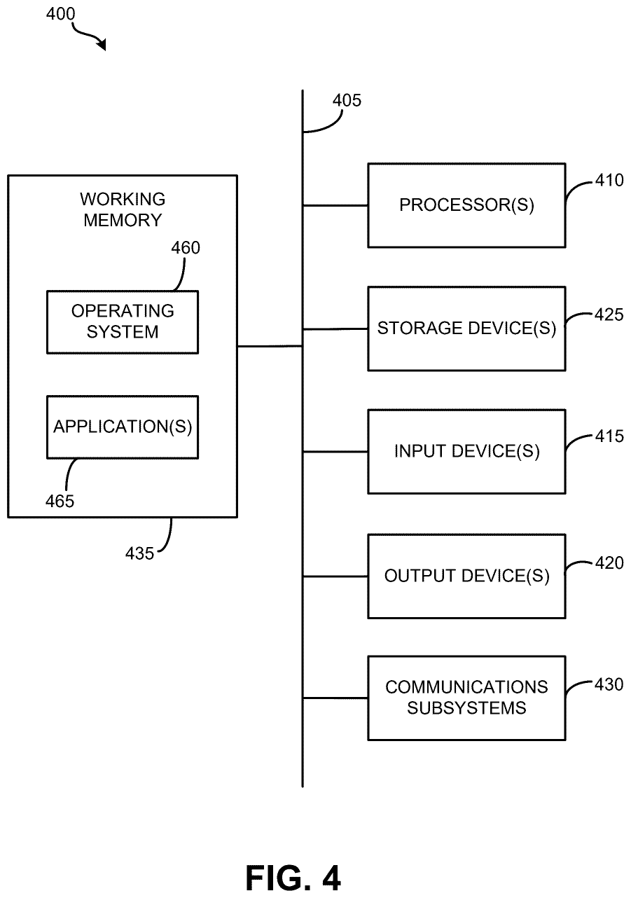

The service provider system, CI/CD system, subsystems, or any components in the system 100A-100B and 200 described above may include a computer system that further includes computer hardware and software that form special-purpose network circuitry to implement various embodiments such as communication, determination, identification, calculation, and so on. FIG. 4 is a schematic diagram illustrating an example of computer system 400. The computer system 400 is a simplified computer system that can be used to implement various embodiments described and illustrated herein. FIG. 4 provides a schematic illustration of one embodiment of a computer system 400 that can perform some or all of the steps of the methods and workflows provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown including hardware elements that can be electrically coupled via a bus 405, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 415, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 425, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g., the first electronic device, may be incorporated into the computer system 400, e.g., an electronic device as an input device 415. In some embodiments, the computer system 400 will further include a working memory 435, which can include a RAM or ROM device, as described above.

The computer system 400 also can include software elements, shown as being currently located within the working memory 435, including an operating system 460, device drivers, executable libraries, and/or other code, such as one or more application programs 465, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 425 described above. In some cases, the storage medium might be incorporated within a computer system, such as computer system 400. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform methods in accordance with various embodiments of the technology. According to a set of embodiments, some or all of the operations of such methods are performed by the computer system 400 in response to processor 410 executing one or more sequences of one or more instructions, which might be incorporated into the operating system 460 and/or other code, such as an application program 465, contained in the working memory 435. Such instructions may be read into the working memory 435 from another computer-readable medium, such as one or more of the storage device(s) 425. Merely by way of example, execution of the sequences of instructions contained in the working memory 435 might cause the processor(s) 410 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 405 then might carry the signals and/or the data, instructions, etc. carried by the signals to the working memory 435, from which the processor(s) 410 retrieves and executes the instructions. The instructions received by the working memory 435 may optionally be stored on a non-transitory storage device 425 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a parameter” includes a plurality of such parameters, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed:

1. A method, performed by a cloud-agnostic continuous integration/continuous deployment (CI/CD) system, comprising:
receiving, in the cloud-agnostic CI/CD system, an artifact associated with an application to be deployed on a target cloud platform from a service vendor;
extracting configuration parameters specific to the target cloud platform of the application from the artifact;
selecting a predetermined cloud-agnostic configuration template containing standardized configuration parameters;
mapping the cloud-specific configuration parameters to the standardized configuration parameters;
determining a reference configuration setting based on the cloud-agnostic configuration template;
storing the reference configuration setting in a repository in the cloud-agnostic CI/CD system, the repository being used as a single source of truth during deployment and lifecycle management of the application;
applying the reference configuration setting to the cloud-agnostic configuration template to generate an initial deployment script; and
executing the initial deployment script to deploy the application on the target cloud platform.

2. The method of claim 1, further comprising:
monitoring continuously the deployed application to determine an actual deployment state;
comparing the actual deployment state with a reference deployment state to determine a difference therebetween;
in response to a determination that the difference exceeds a predetermined threshold, determining a configuration discrepancy associated with the difference; and
performing a reconciliation process to rectify the configuration discrepancy.

3. The method of claim 1, further comprising:
exposing an application programming interface (API) to the service vendor,
wherein the artifact is received through the exposed API.

4. The method of claim 1, further comprising:
storing the artifact in a version-controlled repository of the cloud-agnostic CI/CD system.

5. The method of claim 1, wherein the application is a 5G network function.

6. The method of claim 2, wherein the reference deployment state is determined based on the reference configuration setting.

7. The method of claim 2, further comprising:
determining whether the configuration discrepancy is an infrastructure configuration discrepancy or an application configuration discrepancy.

8. The method of claim 2, wherein the configuration discrepancy is rectified by updating the initial deployment script.

9. The method of claim 1, further comprising:
testing the application in a testing environment before initiating deployment of the application.

10. The method of claim 2, further comprising:
generating a ticket reporting the configuration discrepancy.

11. A cloud-agnostic CI/CD pipeline and orchestration system comprising:
one or more processors; and
a computer-readable storage media storing computer-executable instructions that, when executed by the one or more processors, cause the system to perform:
receiving an artifact associated with an application to be deployed on a target cloud platform from a service vendor;
extracting configuration parameters specific to the target cloud platform of the application from the artifact;
selecting a predetermined cloud-agnostic configuration template containing standardized configuration parameters;
mapping the cloud-specific configuration parameters to the standardized parameters;
determining a reference configuration setting based on the cloud-agnostic configuration template;
storing the reference configuration setting in a repository in the cloud-agnostic CI/CD system, the repository being used as a single source of truth during deployment and lifecycle management of the application;
applying the reference configuration setting to the cloud-agnostic configuration template to generate an initial deployment script; and
executing the initial deployment script to deploy the application on the target cloud platform.

12. The cloud-agnostic CI/CD pipeline and orchestration system of claim 11, wherein, the instructions when executed by the one or more processors, further cause the system to perform:
monitoring continuously the deployed application to determine an actual deployment state;
comparing the actual deployment state with a reference deployment state to determine a difference therebetween;
in response to a determination that the difference exceeds a predetermined threshold, determining a configuration discrepancy associated with the difference; and
performing a reconciliation process to rectify the configuration discrepancy.

13. The cloud-agnostic CI/CD pipeline and orchestration system of claim 11, wherein, the instructions when executed by the one or more processors, further cause the system to perform:
exposing an application programming interface (API) to the service vendor,
wherein the artifact is received through the exposed API.

14. The cloud-agnostic CI/CD pipeline and orchestration system of claim 11, wherein, the instructions when executed by the one or more processors, further cause the system to perform:
storing the artifact in a version-controlled repository of the cloud-agnostic CI/CD system.

15. The cloud-agnostic CI/CD pipeline and orchestration system of claim 11, wherein the application is a 5G network function.

16. The cloud-agnostic CI/CD pipeline and orchestration system of claim 12, wherein the reference deployment state is determined based on the reference configuration setting.

17. The cloud-agnostic CI/CD pipeline and orchestration system of claim 12, wherein, the instructions when executed by the one or more processors, further cause the system to perform:
determining whether the configuration discrepancy is an infrastructure configuration discrepancy or an application configuration discrepancy.

18. The cloud-agnostic CI/CD pipeline and orchestration system of claim 12, wherein the configuration discrepancy is rectified by updating the initial deployment script.

19. The cloud-agnostic CI/CD pipeline and orchestration system of claim 11, wherein, the instructions when executed by the one or more processors, further cause the system to perform:
testing the application in a testing environment before initiating deployment of the application.

20. The cloud-agnostic CI/CD pipeline and orchestration system of claim 12, wherein, the instructions when executed by the one or more processors, further cause the system to perform:
generating a ticket reporting the configuration discrepancy.
